(19) United States
(12) Patent Application Publication
(10) Pub. No.: US 2025/0239776 A1
(43) Pub. Date: Jul. 24, 2025

(54) ANTENNA ARRANGEMENT FOR A VEHICLE

(71) Applicant: VOLVO TRUCK CORPORATION, Goteborg (SE)

(72) Inventor: Daniel Mansson, Goteborg (SE)

(73) Assignee: VOLVO TRUCK CORPORATION, Goteborg (SE)

(21) Appl. No.: 19/004,650

(22) Filed: Dec. 30, 2024

(30) Foreign Application Priority Data
Jan. 19, 2024 (EP) 24152945.2

(51) Int. Cl. H01Q 9/22; H01Q 1/32

(52) U.S. Cl. CPC H01Q 9/22; H01Q 1/32

(57) ABSTRACT

An antenna arrangement for fixation on a vehicle side structure has an antenna housing, a first antenna being a rod antenna protruding from a first end of the antenna housing, the first antenna being configured for transmitting and receiving radio signals, a second antenna arranged in the antenna housing at a second end of the antenna housing opposite the first end. The second antenna is configured at least for receiving satellite signals. When the antenna arrangement is attached to the vehicle side structure the rod antenna is protruding downwards and the second antenna is facing upwards.

### TECHNICAL FIELD

The disclosure relates generally to vehicles. In particular aspects, the disclosure relates to an antenna arrangement for a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

For some vehicles the roof is unavailable for mounting of devices such as antennas. The roofs of such vehicles may for example be occupied by devices carrying cargo. Therefore, it is desirable to arrange antennas elsewhere which may require reorienting the antennas depending on the orientation of the new mounting surface. This may lead to reduced reception performance of the antennas.

### SUMMARY

According to a first aspect of the disclosure, there is provided an antenna arrangement for fixation on a vehicle side structure, the antenna arrangement comprising: an antenna housing, a first antenna being a rod antenna protruding from a first end of the antenna housing, the first antenna being configured for transmitting and receiving radio signals, a second antenna arranged in the antenna housing at a second end of the antenna housing opposite the first end, the second antenna being configured at least for receiving satellite signals, wherein, when the antenna arrangement is attached to the vehicle side structure the rod antenna is protruding downwards and the second antenna is facing upwards.

The first aspect of the disclosure may seek to allow mounting of antennas on side structures of vehicles. A technical benefit may include improved reception for side-mounted antennas. More specifically, the reception of the second antenna may be improved since the view of the second antenna towards the sky is not blocked by the first antenna.

Optionally in some examples, including in at least one preferred example, the antenna arrangement may comprise a support structure for the rod antenna, the rod antenna is electrically connected to the support structure and a fixed end of the rod antenna is optionally attached to the support structure, the support structure may be attached to the antenna housing. A technical benefit may include that a convenient structure is provided that allows for orienting the rod antenna downwards.

Optionally in some examples, including in at least one preferred example, the antenna housing may accommodate a printed circuit board. A printed circuit board provides for a suitable structure for mounting of various components of the antenna arrangement such as the second antenna.

Optionally in some examples, including in at least one preferred example, the support structure may be attached to the printed circuit board at an angle of about 90 degrees. This advantageously provides for the rod antenna to not protrude sideways from the vehicle. In other examples, the angle may lay in the range 45 to 90 degrees, such as 50, 60, 70, or 80 degrees. Angles lower than 90 degrees provides for the rod antenna to protrude somewhat away from the vehicle side structure which advantageously reduces coupling effects from the side structure. Furthermore, the support structure may be angled so that the rod antenna is directed, with some angle, rearwards with respect to the vehicle. This provides aerodynamic advantages such as reduced drag.

Optionally in some examples, including in at least one preferred example, the support structure may be a printed circuit board.

Optionally in some examples, including in at least one preferred example, the antenna arrangement may comprise a base plate attached to the housing, the base plate being adapted for attachment to the vehicle side structure, and for providing electrical ground for the antenna arrangement. Thus, the base plate advantageously provides for both attachment to the vehicle and electrical ground for the antenna arrangement. The base plate may be die casted.

The antenna housing may be attached to a side structure in the form of a side panel of the vehicle via the base plate. The base plate may be more rigid than the vehicle side structure and/or the housing and optional PCBs of the antenna housing, to provide mechanical stability for the antennas.

Optionally in some examples, including in at least one preferred example, the rod antenna and the second antenna may be below the level of the roof of the vehicle when the antenna arrangement is attached to the vehicle side structure. That is, the antenna arrangement allows for keeping the roof area of the vehicle clear of antennas.

Optionally in some examples, including in at least one preferred example, the antenna arrangement may further comprise electrical circuitry for the first antenna, the electrical circuitry being arranged at the first end of the antenna housing. That is, the electrical circuitry is arranged away from the second antenna thereby reducing the risk of interference.

Optionally in some examples, including in at least one preferred example, the rod antenna may be configured for FM broadcast or other radio communication below 1 GHz.

Optionally in some examples, including in at least one preferred example, the second antenna may be a ceramic antenna such as a ceramic patch antenna. Other examples include bi- and quad filament helix antennas.

Optionally in some examples, including in at least one preferred example, the second antenna may be configured to receive and optionally transmit global navigation satellite system, GNSS, signals.

There is further provided a vehicle comprising the antenna arrangement according to the examples.

Optionally in some examples, including in at least one preferred example, the vehicle may be a low-cab vehicle.

According to a second aspect of the disclosure, there is provided a method for assembling an antenna arrangement, the method comprising: providing a first antenna being a rod antenna configured for transmitting and receiving radio signals, providing a second antenna configured at least for receiving satellite signals, arranging the first antenna in an antenna housing such that it protrudes from a first end of the antenna housing, arranging the second antenna in the antenna housing on a second end of the antenna housing opposite the first end, wherein when the antenna arrangement is attached to the vehicle side structure the rod antenna is protruding downwards and the second antenna is facing upwards.

The second aspect of the disclosure may seek to allow mounting of antennas on side structures of vehicles. A technical benefit may include improved reception for side-mounted antennas.

Optionally in some examples, including in at least one preferred example, the method may comprise attaching the antenna arrangement on the vehicle side structure via a base plate of the antenna arrangement attached to the antenna housing.

Optionally in some examples, including in at least one preferred example, the method may comprise attaching the antenna arrangement on the vehicle side structure such that the rod antenna and the second antenna are below the level of the roof of the vehicle when the antenna arrangement is attached to the vehicle side structure. Advantageously, the antenna arrangement allows for keeping the roof area of the vehicle clear of antennas.

Optionally in some examples, including in at least one preferred example, the method may comprise attaching the rod antenna to a support structure, and attaching the support structure to a printed circuit board of the antenna housing, the orientation of the support structure with respect to the printed circuit board being such that the rod antenna protrudes downwards. The angle between the support structure and the printed circuit board may lie in the range 45 to 90 degrees, such as 50, 60, 70, 80, or 90 degrees. Angles lower than 90 degrees provide for the rod antenna to protrude somewhat away from the vehicle side structure which advantageously reduces coupling effects from the side structure. Furthermore, the support structure may be angled so that the rod antenna is directed, with some angle, rearwards with respect to the vehicle. This provides aerodynamic advantages such as reduced drag. At 90 degrees, the antenna does not protrude away from the vehicle structure thereby reducing the risk of impact with external object while the vehicle is moving.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary schematic antenna arrangement according to an example.

FIG. 2A is a front view of a vehicle with a side-mounted antenna arrangement.

FIG. 2B is a perspective view of a vehicle with a side-mounted antenna arrangement.

FIG. 3 is a flow chart of a method to assemble an antenna arrangement according to an example.

FIG. 4 is another view of FIG. 1, according to an example.

### DETAILED DESCRIPTION

The detailed description set forth below provides information and examples of the disclosed technology with sufficient detail to enable those skilled in the art to practice the disclosure.

In certain types of vehicles, the cab roof is unavailable for installation of antennas such as antennas for receiving radio-and satellite-signals. One example type of vehicle may be denoted low-cab truck where the roof is often used for carrying cargo, or for mounting of devices that carries cargo, or that a trailer occupies the roof area, for example for car transport. In one specific example, the roof areas may be used for trailer structure protruding over the cab, e.g. for vehicle transports. In a low-cab truck the cab is lower than in a standard truck which allows for easy access as well as using the roof for cargo.

With the roof unavailable for antenna installation, the antennas must be mounted elsewhere. However, care must be taken so that the new mounting orientation does not lead to interference between the antennas.

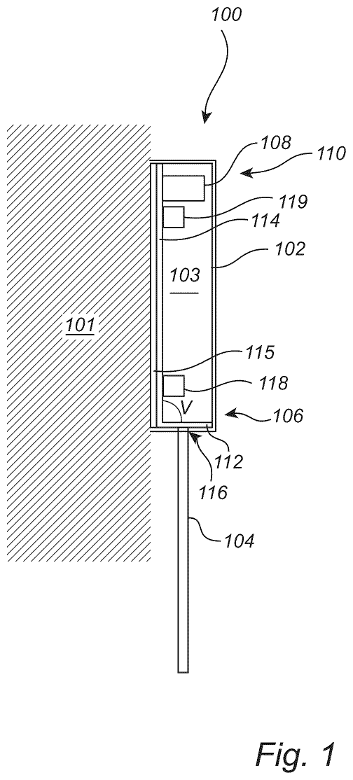

FIG. 1 is an exemplary antenna arrangement 100 according to an example. The antenna arrangement 100 is adapted for fixation on a vehicle side structure 101. The vehicle side structure 101 may be a side panel of a cab of a truck. The vehicle, or truck, may be a so-called low-cab truck.

The antenna arrangement 100 comprises an antenna housing 102 that encloses a volume 103. The antenna housing 102 may be molded or cast in a polymer, e.g., plastic material, or assembled from a set of separate walls.

A first antenna being a rod antenna 104 protrudes from a first end 106 of the antenna housing 102. The first end 106 is considered an external side or wall of the antenna housing 102. The first antenna is configured for transmitting and receiving radio signals. In one example, the rod antenna 104 is configured for FM broadcast or other radio communication below 1 GHz.

A rod antenna may comprise of a rod-shaped conductor, preferably relatively straight. The rod antenna is typically a so-called monopole antenna, known per se in the art. A typical length of such antennas is about ¼ of the wavelength of the signal to be received, a so-called quarter-wave monopole, although shorter antennas are also envisaged. A signal feed is connected to the antenna, preferably close to a ground plane.

A second antenna 108 is arranged in the antenna housing 102 at a second end 110 of the antenna housing 102 opposite the first end 106. The two ends 106 and 110 may lie along a straight line running though the volume 103 of the housing 102.

The second antenna 108 is configured at least for receiving satellite signals. In one example, the second antenna is configured to receive and optionally transmit GNSS signals for a navigation system of the vehicle.

The second antenna being a ceramic antenna such as a ceramic patch antenna that may be attached directly to a printed circuit board 114 or to a further PCB orthogonally attached to the first PCB 114. Other example second antennas are GNSS antennas made from bi- or quad-filament helix' or sheet metal antennas.

When the antenna arrangement 100 is attached to the vehicle side structure 101 the rod antenna 104 is protruding downwards and the second antenna is facing upwards. Downwards is here towards the ground and upwards is towards the sky. That is, the second antenna 108 has a clear view of the sky from which direction the satellite signals are received.

The antenna arrangement 100 comprises a support structure 112 with which the rod antenna 104 is electrically connected and optionally attached. The support structure may provide a mechanical support for the rod antenna 104. However, it is also envisaged that mechanical support is provided by the housing 102, which may be a preferred embodiment. A fixed end 116 of the rod antenna 104 is attached to the housing 102, for example via a threaded connection. That is, the fixed end 116 of the rod antenna may be threaded and fixated into a matching threaded connection in the housing 102. The support structure 112 provides electrical connection between the rod antenna 104 and the PCB 114. Electrical leads of the support structure 112 is then in galvanic connection with the threads of the housing 102. It is also envisaged that the support structure 112 comprises a threaded connection for the rod antenna, in conjunction with a connection to the housing or without the connection to the housing 102.

The support structure 112 is attached to or fixated with respect to the antenna housing 102. Further, the support structure is relatively planar and protrudes at an angle with respect to a base plate 115 of the antenna arrangement. The planar base plate 115 is intended to lay relatively parallel with the external surface of the vehicle side structure 101. The support structure 112 therefore extends away from the vehicle side structure 101 facilitating mounting of the rod antenna 104 so that it protrudes downwards. In examples, the support structure is a printed circuit board, PCB, with electrical leads thereon that connect the rod antenna 104 with the main PCG 114. The base plate 115 may also provide electrical ground for the antenna arrangement. The base plate 115 may be attached to the side structure 101 using brackets, or screws, or other means for attaching the antenna arrangement to the vehicle.

Additionally, the antenna housing 102 accommodates a printed circuit board 114 attached to the base structure 115. The support structure is attached to the printed circuit board at an angle, v, of about 90 degrees which provides for the rod antenna to extend directly, or vertically towards the ground, substantially parallel with the vehicle side structure 101. However, the support structure 112 is attached to the printed circuit board at another angle, v, in the range 45 to 90 degrees, such as 50, 60, 70, 80 degrees such that the rod antenna 104 protrudes tilted and away from the vehicle side structure 101 which reduces the coupling effect of the often-metal vehicle side-structure 101.

The antenna housing 102 may also accommodate electrical circuitry 118 for the first antenna. In this example, the electrical circuitry 118 is arranged at the first end 106 of the antenna housing 102 on the PCB 114 or optionally on the support structure 112. The electrical circuitry 118 includes amplifiers, filters, and other electrical components for signal processing, routing, and enhancement such as signal to noise enhancement, for signals captured by the antenna 104.

The antenna housing 102 may also accommodate similar electrical circuitry 119 for the second antenna 108 preferably at or near the second end 110.

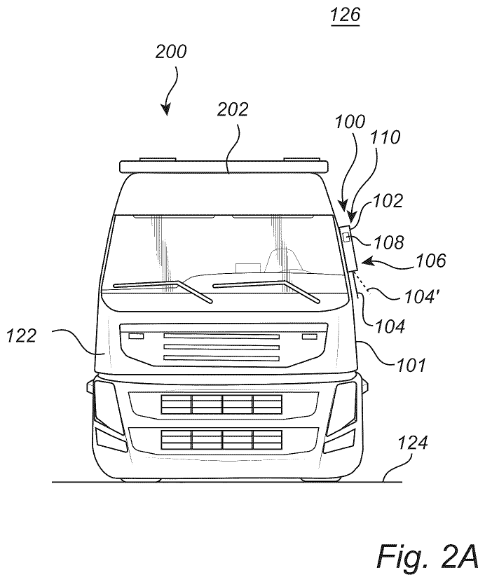

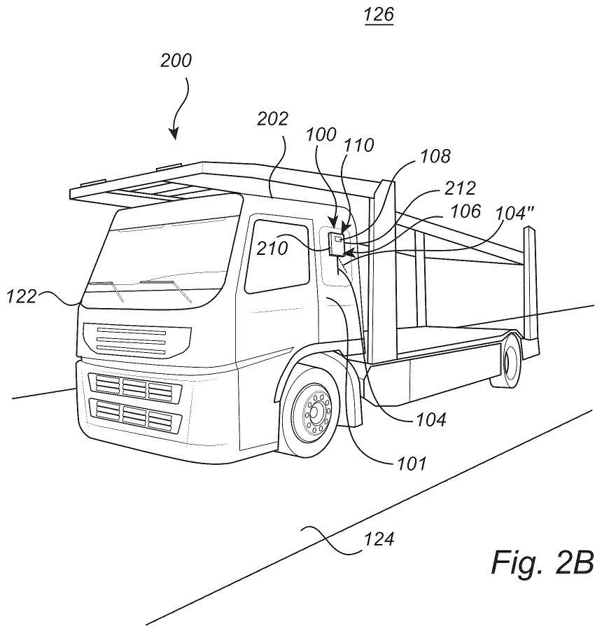

FIG. 2A is a front view of a low-cab truck 200 having an antenna arrangement 100 attached to a side structure 101 of the vehicle cab 122. FIG. 2B is a side view of the truck 200.

The rod antenna 104 is arranged extending away from the first end 106 of the housing 102 towards the ground 124. The second antenna 108 is arranged at the second end 110 with clear path towards the sky 126.

The rod antenna 104 protrudes orthogonally from the housing 102 towards the ground 124. The rod antenna 104 may thus be arranged substantially parallel with the vehicle side structure 101. However, the rod antenna may be tilted away from the vehicle side structure 101 as discussed above and illustrated by the optional rod antenna 104′ in FIG. 2A.

In other examples, the rod antenna may be tilted rearwards of the vehicle 200 illustrated by the optional rod antenna 104″ in FIG. 2B.

The rod antenna 104 and the second antenna 108 are both below the level of the roof 202 of the vehicle when the antenna arrangement 100 is attached to the vehicle side structure such as a side panel 101 of the cab 122.

In addition, the antenna housing 102 may be aerodynamically shaped such that the drag is minimal when the rod antenna 104/104′ protrudes downwards and the second antenna 108 is arranged facing upwards. In other words, in this orientation, the housing 102 has a leading edge 210 configured to encounter an oncoming airflow from the forward direction as the vehicle 200 is travelling. The leading edge 210 may have a streamlined curvature extending along an axis to a trailing edge 212 positioned opposite the leading edge 210, i.e. facing towards the rear of the vehicle 200. The streamlined curvature lies along the axis which intercepts an axis between the first end 106 and the second end 110 of the housing 102. That is, unlike traditional antennas mounted on roofs, the streamlined curvature is from side-to-side of the housing 102, and not from a front antenna (e.g., one of the rod antenna 104 and the second antenna 108) at one end to a rear antenna (e.g., the other one of the rod antenna 104 and the second antenna 108) at another end. If the antenna housing 102 was mounted on the opposite side-struture of the vehicle, still with the rod antenna 104/104′ protruding downwards and the second antenna 108 arranged facing upwards, the leading edge 210 shown here would become the trailing edge and the trailing edge 212 would become the leading edge.

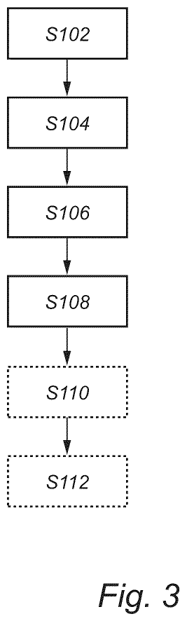

FIG. 3 is a flow-chart of method steps according to examples.

In step S102, providing a first antenna being a rod antenna configured for transmitting and receiving radio signals.

In step S104, providing a second antenna configured at least for receiving satellite signals.

In step S106, arranging the first antenna in an antenna housing such that it protrudes from a first end of the antenna housing.

In step S108, arranging the second antenna in the antenna housing at a second end of the antenna housing opposite the first end, wherein when the antenna arrangement is attached to the vehicle side structure the rod antenna is protruding downwards and the second antenna is facing upwards. The antenna arrangement may be attached on the vehicle side structure via a base plate of the antenna arrangement attached to the antenna housing.

Preferably, the antenna arrangement is attached on the vehicle side structure such that the rod antenna and the second antenna are below the level of the roof of the vehicle when the antenna arrangement is attached to the vehicle side structure.

The method may additionally comprise, in optional step S110, attaching the rod antenna to a support structure, and in optional step S112, attaching the support structure to a printed circuit board of the antenna housing, the orientation of the support structure with respect to the printed circuit board being such that the rod antenna protrudes downwards.

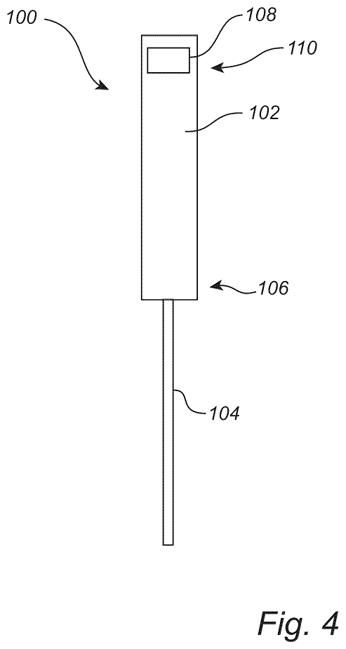

FIG. 4 is another view of FIG. 1, according to an example. FIG. 4 illustrates an antenna arrangement 100 for fixation on a vehicle side structure 101, the antenna arrangement comprising: an antenna housing 102, a first antenna being a rod antenna 104 protruding from a first end 106 of the antenna housing, the first antenna being configured for transmitting and receiving radio signals, a second antenna 108 arranged in the antenna housing at a second end 110 of the antenna housing opposite the first end, the second antenna being at least for receiving satellite signals, wherein, when the antenna arrangement is attached to the vehicle side structure the rod antenna is protruding downwards and the second antenna is facing upwards.

Example 1: An antenna arrangement for fixation on a vehicle side structure, the antenna arrangement comprising: an antenna housing, a first antenna being a rod antenna protruding from a first end of the antenna housing, the first antenna being configured for transmitting and receiving radio signals, a second antenna arranged in the antenna housing at a second end of the antenna housing opposite the first end, the second antenna being configured at least for receiving satellite signals, wherein, when the antenna arrangement is attached to the vehicle side structure the rod antenna is protruding downwards and the second antenna is facing upwards.

Example 2: The antenna arrangement of example 1, further comprising: a support structure for the rod antenna on which the rod antenna is electrically connected and optionally attached.

Example 3: The antenna arrangement of any of examples 1-2, wherein the antenna housing accommodates a printed circuit board.

Example: 4 The antenna arrangement of examples 2 and 3, wherein the support structure is attached to the printed circuit board at an angle of about 90 degrees.

Example 5: The antenna arrangement of any of examples 1-2, wherein the support structure is a printed circuit board.

Example 6: The antenna arrangement of any of examples, comprising a base plate attached to the housing, the base plate being adapted to for attachment to the vehicle side structure, and for providing electrical ground to for the antenna arrangement.

Example 7: The antenna arrangement of any of examples 1-6, wherein the rod antenna and the second antenna being below the level of the roof of the vehicle when the antenna arrangement is attached to the vehicle side structure.

Example 8: The antenna arrangement according to any of examples 1-7, further comprising electrical circuitry for the first antenna, the electrical circuitry being arranged at the first end of the antenna housing.

Example 9: The antenna arrangement according to any of examples 1-8, the rod antenna being configured for FM broadcast or other radio communication below 1 GHz.

Example 10: The antenna arrangement according to any of examples 1-9, the second antenna being a ceramic antenna.

Example 11: The antenna arrangement according to any of examples 1-10, the second antenna being configured to receive and optionally transmit GNSS signals.

Example 12: A vehicle comprising the antenna arrangement according to any of examples 1-11.

Example 13: The vehicle according to example 12, wherein the antenna housing is attached to a side structure in the form of a side panel of the vehicle via a base plate.

Example 14: The vehicle according to any one of examples 12-13, the vehicle being a low-cab vehicle.

Example: 15: A method for assembling an antenna arrangement, the method comprising: providing a first antenna being a rod antenna configured for transmitting and receiving radio signals, providing a second antenna configured at least for receiving satellite signals, arranging the first antenna in an antenna housing such that it protrudes from a first end of the antenna housing, arranging the second antenna in the antenna housing on a second end of the antenna housing opposite the first end, wherein when the antenna arrangement is attached to the vehicle side structure the rod antenna is protruding downwards and the second antenna is facing upwards.

Example 16: The method according to example 14, comprising: attaching the antenna arrangement on the vehicle side structure via a base plate of the antenna arrangement attached to the antenna housing.

Example 17: The method according to example 14, comprising: attaching the antenna arrangement on the vehicle side structure such that the rod antenna and the second antenna are below the level of the roof of the vehicle when the antenna arrangement is attached to the vehicle side structure.

Example 18: The method according to any of examples 15-17, comprising: electrically connecting the rod antenna to a support structure, and attaching the support structure to a printed circuit board of the antenna housing, the orientation of the support structure with respect to the printed circuit board being such that the rod antenna protrudes downwards.

Example 19: The method according to any of examples 15-18, the rod antenna being configured for FM broadcast or other radio communication below 1 GHz.

Example 20: The method according to any of examples 15-18, the second antenna being a configured to receive and transmit GNSS signals.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. An antenna arrangement for fixation on a vehicle side structure, the antenna arrangement comprising:
an antenna housing,
a first antenna being a rod antenna protruding from a first end of the antenna housing, the first antenna being configured for transmitting and receiving radio signals,
a second antenna arranged in the antenna housing at a second end of the antenna housing opposite the first end, the second antenna being configured at least for receiving satellite signals, wherein, when the antenna arrangement is attached to the vehicle side structure the rod antenna is protruding downwards and the second antenna is facing upwards.

2. The antenna arrangement of claim 1, further comprising:
a support structure for the rod antenna, the rod antenna is electrically connected to the support structure and a fixed end of the rod antenna is optionally attached to the support structure, the support structure being attached to the antenna housing.

3. The antenna arrangement of claim 1, wherein the antenna housing accommodates a printed circuit board.

4. The antenna arrangement of claim 2, wherein the support structure is attached to the printed circuit board at an angle of about 90 degrees.

5. The antenna arrangement of claim 1, wherein the support structure is a printed circuit board.

6. The antenna arrangement of claim 1, comprising a base plate attached to the housing, the base plate being adapted to for attachment to the vehicle side structure, and for providing electrical ground to for the antenna arrangement.

7. The antenna arrangement of claim 1, wherein the rod antenna and the second antenna being below the level of the roof of the vehicle when the antenna arrangement is attached to the vehicle side structure.

8. The antenna arrangement according to claim 1, further comprising electrical circuitry for the first antenna, the electrical circuitry being arranged at the first end of the antenna housing.

9. The antenna arrangement according to claim 1, the rod antenna being configured for FM broadcast or other radio communication below 1 GHz.

10. The antenna arrangement according to claim 1, the second antenna being a ceramic antenna.

11. The antenna arrangement according to claim 1, the second antenna being configured to receive and optionally transmit GNSS signals.

12. A vehicle comprising the antenna arrangement according to claim 1.

13. The vehicle according to claim 12, wherein the antenna housing is attached to a side structure in the form of a side panel of the vehicle via a base plate.

14. The vehicle according to claim 12, the vehicle being a low-cab vehicle.

15. A method for assembling an antenna arrangement, the method comprising:
providing a first antenna being a rod antenna configured for transmitting and receiving radio signals,
providing a second antenna configured at least for receiving satellite signals,
arranging the first antenna in an antenna housing such that it protrudes from a first end of the antenna housing,
arranging the second antenna in the antenna housing on a second end of the antenna housing opposite the first end, wherein when the antenna arrangement is attached to the vehicle side structure the rod antenna is protruding downwards and the second antenna is facing upwards.

16. The method according to claim 15, comprising: attaching the antenna arrangement on the vehicle side structure via a base plate of the antenna arrangement attached to the antenna housing.

17. The method according to claim 15, comprising: attaching the antenna arrangement on the vehicle side structure such that the rod antenna and the second antenna are below the level of the roof of the vehicle when the antenna arrangement is attached to the vehicle side structure.

18. The method according to claim 15, comprising: electrically connecting the rod antenna to a support structure, and attaching the support structure to a printed circuit board of the antenna housing, the orientation of the support structure with respect to the printed circuit board being such that the rod antenna protrudes downwards.

19. The method according to claim 15, the rod antenna being configured for FM broadcast or other radio communication below 1 GHz.

20. The method according to claim 15, the second antenna being a configured to receive and transmit GNSS signals.
